(19) United States
(12) Patent Application Publication
(10) Pub. No.: US 2008/0180391 A1
(43) Pub. Date: Jul. 31, 2008

(54) CONFIGURABLE ELECTRONIC INTERFACE

(76) Inventors: Joseph Auciello, Simi Valley, CA (US); Lucinda G. Price, Windsor, CA (US)

Correspondence Address: SCHWEGMAN, LUNDBERG & WOESSNER, P.A., P.O. BOX 2938, MINNEAPOLIS, MN, 55402, US

(21) Appl. No.: 11/972,414

(22) Filed: Jan. 10, 2008

Related U.S. Application Data
(60) Provisional application No. 60/884,555, filed on Jan. 11, 2007.

(51) Int. Cl. G09G 5/00

(52) U.S. Cl. 345/156

(57) ABSTRACT

An electronic interface comprising a scrolling panel including a plurality of image slides, the plurality of image slides including at least one video slide, the plurality of image slides in a scrolling slideshow; and a main panel including one of the plurality of image slides selected to be featured.

### RELATED APPLICATION

This application claims priority under 35 U.S.C. §119(e) to U.S. Provisional Patent Application No. 60/884,555, filed Jan. 11, 2007, which is incorporated herein by reference.

### TECHNICAL FIELD

The present application relates generally to the technical fields of data processing, information technology, and electronic communication, and, in one specific example, to a method and system of publishing a configurable electronic interface.

### BACKGROUND

Often there is a plethora of information that may be displayed or offered to users of an interface. In many applications, web links may be used to direct users to web sites or alternate web pages in the event that much of the relevant information may not fit on the current interface in a quick and easy-to-view format.

### BRIEF DESCRIPTION OF THE DRAWINGS

Some embodiments are illustrated by way of example and not limitation in the figures of the accompanying drawings in which:

FIG. 1 illustrates a network diagram depicting a system, according to an example embodiment, having a client-server architecture.

FIG. 2 illustrates a block diagram showing application(s) in an example embodiment.

FIG. 3 illustrates a high-level entity-relationship diagram, illustrating various tables that may be maintained within one or more databases, according to an example embodiment.

FIG. 4 illustrates an interface in an example embodiment.

FIG. 5 illustrates a diagrammatic representation of a machine in the form of a computer system within which a set of instructions, for causing the machine to perform any one or more of the methodologies discussed herein, may be executed, according to an example embodiment.

### DETAILED DESCRIPTION

Example system and method publish a streaming video with scrolling slideshow and synchronized text. A configurable interface comprises a scrolling panel. The scrolling panel includes a plurality of image slides, the plurality of image slides including at least one video slide. The plurality of image slides are in a scrolling slideshow. The interface further includes a main panel having one of the plurality of image slides selected to be featured.

It is said that pictures are worth a thousand words. Pictures are one way to convey information in a quick and easy-to-view format. Further, video may convey even more information.

In the following description, for purposes of explanation, numerous specific details are set forth in order to provide a thorough understanding of example embodiments. It will be evident, however, to one skilled in the art that the present invention may be practiced without these specific details.

### Architecture

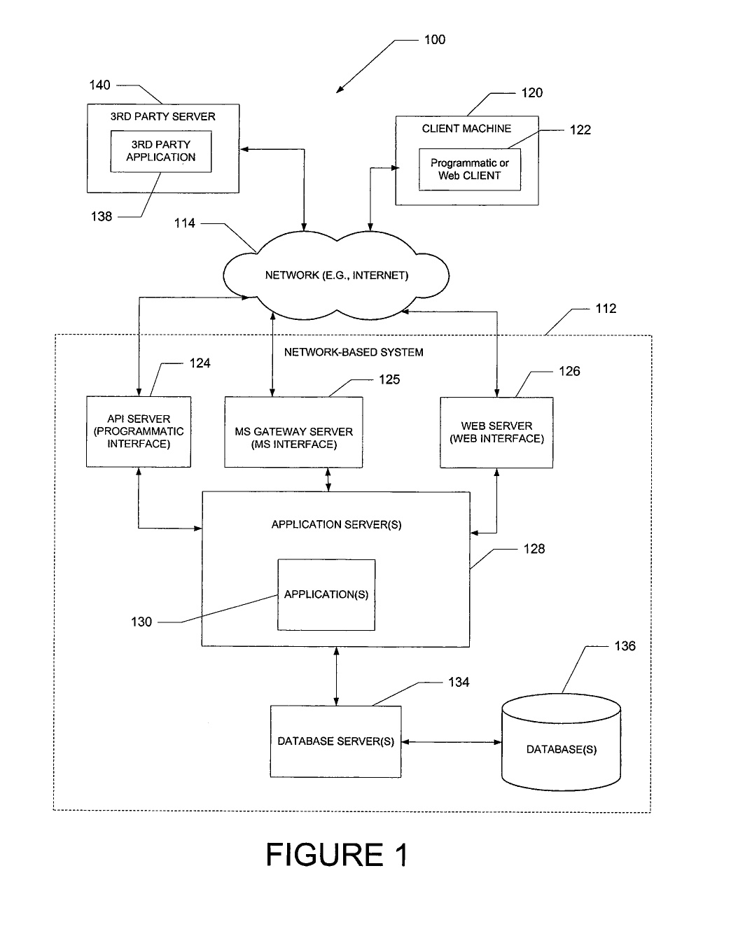

FIG. 1 illustrates a network diagram depicting a system 100 having a client-server architecture, according to an example embodiment of the present invention. A system, in the example form of an electronic system 112, provides server-side functionality, via a network 114 (e.g., the Internet, a public or private telephone network (wireline or wireless), a private wireless network using technologies such as Bluetooth or IEEE 802.11x or other networks) to one or more clients. FIG. 1 illustrates, for example, a client 122, such as a web client (e.g., a browser, such as the Internet Explorer® browser developed by Microsoft®, a device application, and/or a programmatic client executing on client machine 120, e.g. On a network-based device. Further, while the system 100 shown in FIG. 1 employs a client-server architecture, embodiments are of course not limited to such an architecture, and could equally well find applications in a distributed, or peer-to-peer, architecture system.

The network 114 may include a mobile telephone network, a wireless wide area network (WWAN), a wireline telephone network, a wireless local area network (wireless LAN or WLAN), a wireless Metropolitan Area Network (MAN), and/or a wireless personal area network (PAN) (e.g., a Bluetooth® network). Other network-based technologies that may be used to connect include PON, VSAT satellite, Micro-impulse Radar, Radio Frequency identification (RFID), ultrawide Band, and/or Infrared. The network-based device may connect to the web using mobile internet exchange, e.g. Wireless Application Protocol (WAP) and/or Hypertext Transport Protocol (HTTP).

The client machines, including network-based device(s) 120, may include a mobile device, a palmtop computer, a laptop computer, a desktop computer, a personal digital assistant, a cellular telephone, a communications device, a wireless telephone, a land-line telephone, a control system, a camera, a scanner, a television, television cable, a telephone with a web browser, a facsimile machine, a printer, a pager, and/or a personal trusted device. The device 120 may include a card, such as a smart card, a magnetic card, and/or a key card. The device may include a telephone or any device capable of Short Messaging Service (SMS) messaging, instant messaging (IM), text messaging, multimedia messaging service (MMS) messaging and/or generating audio tones, such as dual-tone multi-frequency (DTMF) tones. The device may be browser-enabled. The device 120 may enable mobile videophone communications, digital television signals, and/or digital radio signals. The device may include a receiver to receive near field communications. The scanner device may include a bar code reader/scanner, a Radio Frequency Interface System (RFIS) reader, and/or a symbol reader/scanner.

The device 120 may engage in an interactive message and/or open communication session, such as SMS, IM, electronic mail, xHTML, Wireless Application Protocol (WAP), web, interactive voice response (IVR) and/or other mobile interfaces. The interactive messaging or open communication session may involve multiple technology modalities, e.g., the client user may engage the system via IM and receive a responsive communication from the system 112 via e-mail with an embedded hyperlinked URL directing the client user's device to a WAP or web page or via a telephone call. A hyperlinked URL may be delivered directly to the device from one or more application server(s) 128 of system 112 and may be used to access a web site or a microbrowser, such as a WAP site.

Turning specifically to the network-based system 112, the one or more application servers 128 may host one or more application(s) 130 that may provide a number of functions and services to client users. The client user may include a viewer, a seller, a buyer, and/or third parties, such as anyone who may access the system 112. The applications 130 may provide a number of mechanisms whereby a user may list business or personal images and video or text. The images and video may be associated with goods or services for sale, or may be educational, or personal, or a news story, or may be for security purposes, in a physical marketplace, day care center, or office building complex, for example.

In the instance where the device 120 accesses the application 130 via the MS Interface, the client device 120 may use a messaging service.

The device 120 may access the application servers 128, such as the various applications 130, via a system interface. The system interface between the device 120 and the applications 130 may include a web interface supported by a web server 126, via a programmatic interface supported by an Application Program Interface (API) server 124, and/or via a Messaging Service (MS) Interface supported by the MS Gateway Server 125. The web interface may include a web browser or any microbrowser, such as xHTML or WAP. Similarly, the programmatic client 122 accesses the various services and functions provided by the application server(s) 128, via the programmatic interface provided by the API server 124 and/or the web server 126. The programmatic client 122 may, for example, be a user application (e.g., the TurboLister® application) to enable users to author and manage listings on the networked system 112 in an off-line manner, and to perform batch-mode communications between the programmatic client 122 and the networked system 112.

In an additional embodiment, an application supported by one or more applications of the application server(s) may be downloadable to the network-based device. The device(s) may host the interface associated with the one or more applications of the application server(s) 128. The interface on the device may be an API interface, an MS interface, a web interface, and/or another other appropriate communication interface. Consumer wireless device platforms, such as Java 2 Platform Micro Edition (J2ME), J2SE and J2EE allow developers to use Java and a wireless toolkit to create applications and programs for the device 120. The J2ME interface may include an application programming interface (API) for the device. The application of the programmatic client may also access the Internet using, for example, Binary Runtime Environment for Wireless (BREW).

The client 122, for example, the programmatic client, executed on the client machine 120 may access the application server(s) 128 via the web interface of the web server. The programmatic client may be selected on the device and the Internet may be launched in a background. The programmatic client may additionally or alternatively access the server(s) 128 via the MS interface of the MS Gateway server 125, and/or via the programmatic interface of the API server 124. In an embodiment, the downloaded application described herein may include the programmatic client.

The system 112 and the various applications 130 may also be implemented as standalone software programs, which do not necessarily have networking capabilities. In this example, the device 120 may be directly connected to the application(s) 130, without using the network 114. The electronic system 112 may be any online marketplace, for example, www.walmart.com, www.ebay.com or www.llbean.com.

The application server(s) 128 may be coupled to one or more database servers 134 that facilitate access to one or more databases 136. The application(s) may have access to the database 136 having, for example, personal user account information. The user account information may include payment information associated with the client user and an address destination of the client user, for example.

The client 122 may operate a program supported by the one or more database server(s) 134. The database server(s) 134 may support one or more account information links on a user interface of the network-based device, for example, using the web client 122. By accessing the database server(s) 134, the client user may add, amend or delete account information of the client user, among other information.

### Application Server(s)

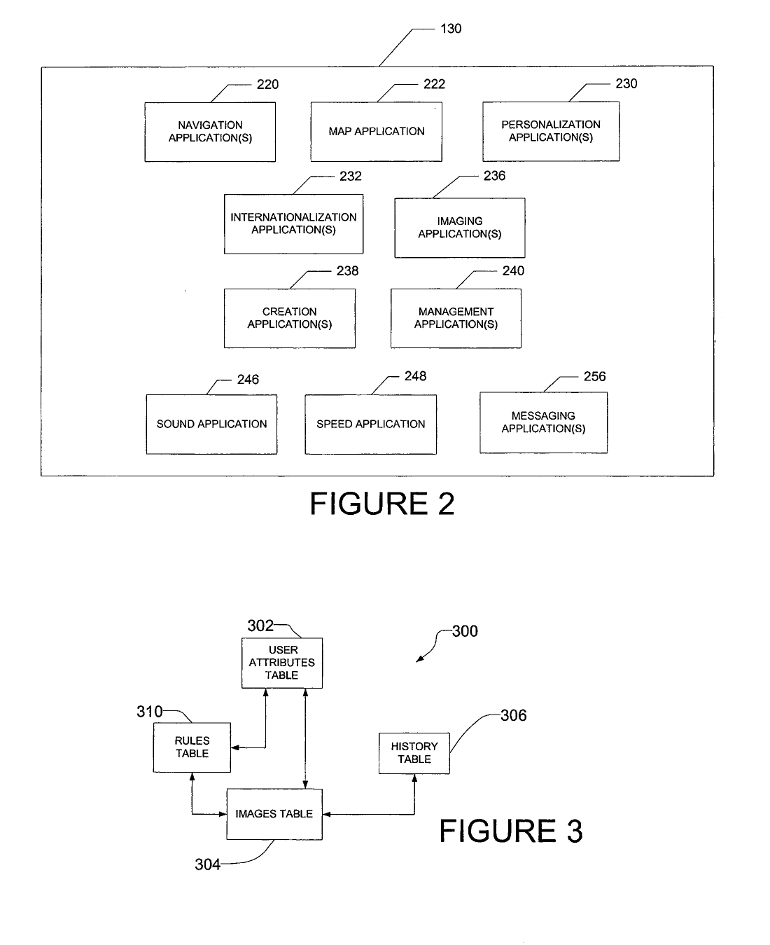

FIG. 2 illustrates a block diagram showing application server(s) that are part of the network-based system 112, in an example embodiment of the present invention. In this embodiment, the application(s) 130 may be hosted by the application server(s) 128 of the network-based system 112. The application 130 may be hosted on dedicated or shared server machines (not shown) that are communicatively coupled to enable communications between server machines. The applications themselves may be communicatively coupled (e.g., via appropriate interfaces) to each other and to various data sources, so as to allow information to be passed between the applications or so as to allow the applications to share and access common data.

Navigation of the online electronic system may be facilitated by one or more navigation applications 220. For example, a search application (as an example of a navigation application) may enable key word searches of listings published via the networked system 112. A browse application may allow users to browse various category, catalogue, or inventory data structures according to which listings may be classified within the networked system 112. Various other navigation applications may be provided to supplement the search and browsing applications.

The navigation application(s) may include a user initiated search of content on the interface 400 via a text search. The text search may be of extracted text from video content. The navigation application(s) may include a loop or looping scroll control bar 415 to quickly maneuver through the image panels in the scrolling panel 410. The navigation application(s) may also include an automatic internet search for images and/or videos for the scrolling panel 410 based on a user associated setup.

Map applications 222 to have a link to a map associated with the image panel.

Personalization applications 230 allow users of the networked system 112 to personalize various aspects of their interactions with the networked system 112. For example, a user may, utilizing an appropriate personalization application 230, create a personalized reference page at which information regarding images to which the user is (or has been) viewing may be made available. Further, the personalization application(s) 230 may enable a third party to personalize products and other aspects of their interactions with the system 112 and other parties, or to provide other information, such as relevant business information about themselves.

The application 130 may include one or more internationalization applications 232. In one embodiment, the network-based system 112 may support a number of marketplaces that are customized, for example, for specific geographic regions. A version of the system 112 may be customized for the United Kingdom, whereas another version of the system 112 may be customized for the United States. Each of these versions may operate as an independent marketplace, or may be customized (or internationalized) presentations of a common underlying marketplace. The networked system 112 may accordingly include a number of internationalization applications 232 that customize information (and/or the presentation of information) by the networked system 112 according to predetermined criteria (e.g., geographic, demographic or marketplace criteria). For example, the internationalization applications 232 may be used to support the customization of information for a number of regional websites that are operated by the networked system 112 and that are accessible via respective web servers.

In order to make listings, available via the networked system 112, as visually informing and attractive as possible, the applications 130 may include one or more imaging applications 236 utilizing which users may upload images for inclusion within listings. An imaging application 236 also operates to incorporate images within viewed listings. The imaging applications 236 may also support one or more promotional features, such as image galleries that are presented to potential buyers. For example, users may generally pay an additional fee to have an image included within a gallery of images for promoted items.

Creation applications 238 allow users conveniently to author their interface or electronic book pertaining to images of use. The authoring feature, for example, may allow pictures to be uploaded in a variety of ways, with a audio and/or textual description of each image. The file may include may be transmitted electronically to other users.

Management applications 240 allow users to manage the interface 400. Specifically, where a particular user has authored and/or published a large number of images, the management of such images may present a challenge. The application 240 aids in such management.

The sound application(s) 246 may provide mechanisms whereby sound may be played using the sound control panel 430. Spoken words describing the content of a scrolling image may be played when an image on the scrolling panel is displayed.

The application server(s) 128 may include messaging applications 256. The messaging applications 256 are responsible for the generation and delivery of messages to client users and third parties of the network-based system 112. Information in these messages may be pertinent to services offered by, and activities performed via, the application(s) 130.

Such messages, for example, advise client users regarding the status of products (e.g., providing “new image” notices to client users) or payment status (e.g., providing receipt for payment, Notification of a Payment Received, delivery status, invoice notices). Third parties may be notified of a product order, payment confirmation and/or shipment information. Respective messaging applications 256 may utilize any one having a number of message delivery networks and platforms to deliver messages to users. For example, messaging applications 256 may deliver electronic mail (e-mail), instant message (IM), Short Message Service (SMS), text, facsimile, or voice (e.g., Voice over IP (VOIP)) messages via the wired (e.g., the Internet), Plain Old Telephone Service (POTS), or wireless (e.g., mobile, cellular, WIFI, WIMAX) networks.

### Data Structures

FIG. 3 illustrates a high-level entity-relationship diagram, having various tables 300 that may be maintained within the database(s) 136 according to an example embodiment. The tables 300 may be utilized by and support the application(s) of the application server(s). The database(s) 136 may, in one embodiment, be implemented as a relational database, and includes a number of tables having entries, or records, that are linked by indices and keys. In an alternative embodiment, the database(s) 136 may be implemented as a collection of objects in an object-oriented database.

A user attributes table 302 includes a record for each registered user of the networked system 112.

The tables 300 also include an images table 304 for each item of an image or a video that have been found or displayed for the user, according to criteria associated with the user. The images table 304 may be images uploaded from the user and/or images found during a search of the Internet using the navigation application. The images may be still images and/or video images. The images may be uploaded by a server, for instance. The images may be automatically uploaded to the interface upon triggering of an event, or may be automatically uploaded periodically, for instance. The images may also be viewed in substantial real-time.

A history table 306 maintains a history of images displayed and details concerning the images, such as origin.

A rules table 310 is generated by user input. The rules table 310 determines which images and video are displayed in the scrolling panel 410. The rules table 310 may be used by the navigation application to automatically find videos or images on the Internet that match the criteria set out in the rules, for instance.

### User Interface

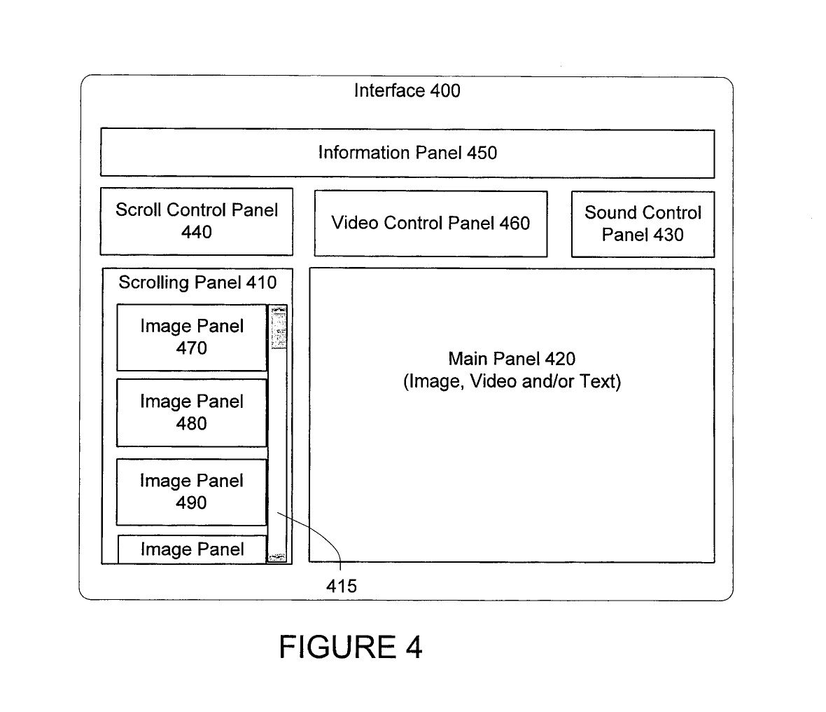

FIG. 4 illustrates a user interface 400, for example a website of the network-based commerce system.

In an embodiment, the interface may be presented in an “electronic book” format. Similar to physical books, the electronic book interface may include a table of contents, which allows direct access to a page or topic through a link, for example, and the electronic book interface may include sequential pages. The pages (or slides) may be turned sequentially in either direction, starting from anywhere, including 1^{st} and last pages, or the pages may be accessed directly from the Table of Contents. The pages may also be viewed one-at-time at a variable speed rate. The electronic book may have a reading rate that varies from slow to fast, and may be customized by the user of the interface.

The interface presentation may allow a user to scan visual icons that represent information in a database quickly and efficiently. Giving the user almost the same level of access that he/she has with an interface may make a significant difference in how a user can learn information.

The interface 400 may be on a webpage, for instance. The presentation or interface may include several panels or panel categories. These panels include functions which are a superset of the operation of watching a video, a plurality of videos, images and/or images with text, or reading a book.

Scroll Control Panel 440 includes controls for the scrolling slide show scrolling panel 410 below. Video control panel 460 includes the controls for the slide show or video at main panel 420. Information Panel 450 includes a horizontal scrolling text bar. Scrolling Panel 410 includes scrolling thumbnail images which represent larger images or video or title or text in main panel 420. Scrolling panel 410 is controlled by buttons in scroll control panel 440. Main panel 420 includes enlarged video or images and text which go with the images. Sound control panel 430 includes buttons that play music or turn off the music. Also, when the presentation starts, the following events occur simultaneously. The Table of Contents, scrolling panel 410, begins to scroll upward at a slow rate, slides begin to change slowly in main panel 420, text begins to scroll automatically, and in synch sound, e.g., reading a text from audio portion of video, and background music, begins to play.

Scrolling Panel 410 functions like a book index or Table of Contents. The user may find the sought image in the table of contents and then be able to select the image to view it in the main panel 420. In another embodiment, as the image automatically scrolls through the scrolling panel 410 and attains at least a certain percentage of ‘screen real estate’, then the image may also be reproduced automatically at the main panel 420 simultaneously. The main panel 420 may then vary with the images of the scrolling panel 410 as they scroll. Sound and text may accompany the image in the main panel 420.

Further, the interface may allow the Table of Contents (scrolling panel 410) to be updated, revised, added to, or deleted from per live, substantially live, or new information coming from Web Feeds, for instance, from a server or a network. The scrolling panel 410 may also include subscriber real-time syndication signal, movies, images, music, podcasts, cybercasts, streamed video, redirected TV signals, radio simulcast, video-on-demand, knowbots, VOIP video calls or phone calls, instant messaging, interrelay chat, radio stations.

There may be both still images and video in the scrolling panel 410. FIG. 4 shows a representative scroll of images, including image panels 470, 480 and 490. The image panels 470, 480, 490 may be scrolling as videos (if the corresponding content is video), the image panels may be scrolling as still images (if the corresponding content is video), and the image panels may be scrolling as still images (if the corresponding content is still images). The Scrolling Table of Contents (STOC) may also be scrolled manually using the scroll control panel 440. The scroll may be vertical or horizontal, for example.

The scrolling panel 410 may have an image panel, for example image panel 480, that automatically pops up in the main panel 420 to play the video or display the image. The videos (for the length of the video or a predetermined length of time—the video may just loop around if finished quickly or may stop) and/or images (for a predetermined length of time) in the scrolling panel 410 may be played successively in series in the main panel 420 automatically or as set up by the user. The scrolling panel 410 may automatically slow down as a video of the selected image panel is displayed and played out in the main panel 420 or as the image of the selected image panel is displayed on the main panel 420 for a specified period of time.

Image panel 480 in the scroll 410 may be selected. In an embodiment, selection of the image panel 480 may occur simply by hovering a cursor control over the image panel 480. Text corresponding to the image panel 480 may appear as a pop up on the interface 400, or may appear in the main panel 420, for instance. In an embodiment, upon selection of the image panel 480, the corresponding image or video (and text, if applicable) may be presented in the enlarged format at the main panel 420.

Text may accompany the enlarged image or video. The text panel may be adjacent the main panel 420, for example, at the right or left-side of the window, just below its controls and the horizontal scrolling text bar. The images may change as set by the user's specifications, for example. There may be approximately 2 images per second (120 slides per minute).

The number of images displayed at any one time in the scrolling panel 410 may varying per the user's preference, screen size, thumbnail size, or other appropriate variables.

This scrolling motion of the display of the array of thumbnail images is meant to be the way to search or navigate for information (image and text) to be displayed in main panel 420. The function of the scrolling panel 410 includes providing a quick way of searching the contents of the presentation, and allowing direct access to the information.

Images of maps, for example, driving directions may be included in the scrolling panel. Maps from the web may be screen-captured, and may accompany verbal information. Computer utilities may be added to the panel 410, such as the Windows Calculator that may accept verbal input of formulas, for example, loan amortization or future value formulas, and output the results verbally to a user who may be wearing a hands-free headset which may be used while driving or performing other tasks, for example.

In some embodiments, there may be at least one still image and at least one video image in the slide show of the main panel 420. The image may include accompanying text in the main panel. The presentation is about accessing and viewing information in a comprehensive, efficient way using a visual-interface. The visual power of the image may maximize the impact of the text, which in turn allows possible textually-emphasized details of the image to now be noticed. Integrating visual materials with text materials may achieve a higher level of comprehension.

In one example, the center panel includes, control buttons that display single, specific images which are controlled by buttons such as: First Slide, Next, Back, Last Slide, Play and Stop. Images may be selected by a number of ways, for example: automatically through a Play button, manually with the ‘first, last, next’ buttons, or accessed by hovering over the corresponding scrolling image in the panel 410.

There may be a single text box that accompanies a selected image, or several text boxes accompanying several images. The text in main panel 420 may follow the audio portions closely, may paraphrase the audio portions of the video, or may include a summary or topic sentence. The text may be extracted from audio portions of the video using, for example, closed caption technology, or another technology to extract the text from the video(s). Further, audio may be generated from text. Musical notes may be extracted from audio portions as well. The text may be gathered from subtitles and/or closed captions, from program transcripts, or from speech recognition, for instance. The text may be gathered from program information that is transmitted with the program (if the program is a broadcast program or segment), or from a database, such as the Internet. The program information may include genre (news, movie, or comedy, for instance), actors/actresses, summary, year made, length of program, and other program-related information. The text may include terms, such as “Yankees,” or something less specific, such as “baseball.”

To control the scrolling panel 410, the Scroll Control Panel 440 may be used. The panel 440 may include a speed indicator box, Direction toggle button (or Up and Down arrows), Stop button, Slower and Faster buttons. The Speed Indicator box shows the rate of the vertical scrolling images. The speed ranges from 1 (slow) to 20 (fast) and is for display only with its values incremented or decremented by 2 with the pressing of the Slower/Faster buttons. In an example, pressing “Slower” reduces the speed of the vertical scrolling images by 2, so if the rate were 8, pressing “Slower” slows the speed to 6. The direction toggle button changes the direction of the scrolling slide show, e.g., from bottom-to-top to top-to-bottom. The Stop button stops the scrolling movement. The Slower/Faster buttons control the speed of the slides, the vertical scrolling slides which are slightly-larger-than-thumbnail images which access their enlarged counterparts in zones when the cursor is pointed at them.

The vertical scrolling slides represent a visual manifestation of a Table of Contents. Viewing the scrolling thumbnail images to find the topic to be viewed is done by hovering or pointing the cursor at the image. Substantially immediately, the corresponding image with text appears in Main panel 420.

The buttons may include speed and direction buttons for the vertical scrolling slide show. Up and Down arrow change the direction from bottom to top or top to bottom. The Slower and Faster buttons control the scroll rate from approximately 20 images per minute to 120 images per minute. A Stop button will stop the process.

In another embodiment, scroll control panel 440 is optional. The cursor control may hover over scrolling panel 410 while a control button associated with the cursor controller may be pressed to display a pop-up menu with options to control the scrolling panel 410 in much the same way as the scroll control panel 440 does. Also, one of the buttons on the cursor control (e.g., a mouse) may “stop” or “start” the scroll, for instance. When the cursor hovers over the scrolling panel 410, the scroll may momentarily stop until the cursor pointer moves outside the scrolling panel 410.

Recorded phone messages, whose iconic symbol naming the source information (name, phone number, time) may be shown on the panel 410. A corresponding text version may shown in the information panel 450. Buttons in the control panel 460 may include options to return a call, archive the message, delete the message, modify a message, to return call at a later time, or to forward the message. Recorded messages may include directions, maps, personal action items, or other images, text, or audio portions.

The scrolling panel 410 may be navigated using the looping scroll control bar 415. For instance, the scroll bar 415 may be located along the image panels 470-490 to quickly scroll through the various image panels. The looping scroll bar may have a button that moves from one end of the scrolling panel 410 to an opposite end of the scrolling panel. When the button reaches one end of the scrolling panel, the button moves back along the scrolling panel with the associated image panel. Therefore, the button may stay with one selected image panel automatically moving from one end of the scrolling panel to the opposite end and back again until the button is moved by selection of the cursor, for instance. In this way, because the image panels 470-490 loop around, no image panel is perpetually at the ‘bottom’ of the scroll and a scroll through the looping image panels may be effectuated.

The Video Control Panel 460 may control the Slide Show with Text. These are the controls for the Slide Show in main panel 420. All images have text to accompany them in main panel 420. The rationale is viewing an image communicates a range of information to the reader, while accompanying text does the same. After viewing both, each augments, reinforces, and extends the other: Critically-reading the text highlights features of the picture, while viewing the image brings up reading comprehension, elevating words to their ‘connotative’ level, seeing words as ‘painting a picture’! Pressing the “First” button causes the first image to appear. The “Back” button skips back one slide. The “Next” button skips forward one slide. The “Last” button shows the last image. The “Stop” button stops the playing of the slide show, which rate is 30 slides per minute. The “Slower” button slows down the playing rate by approximately 10%. The “Faster” button increases the playing rate by approximately 10%.

One command button has two left-pointing arrows (<<) for a quick-speed return to the First slide beginning of the slideshow, and another command button has two right-pointing arrows (>>) that allows the user to go to the Last slide. A Back command button consists of one left pointing arrow (<) to go back, and in a Next command button with a right pointing (>) button that allows a user to proceed to the next slide. Just beneath the slideshow speed command buttons are additional command buttons for the same slideshow that say: Stop, Slower, Play, and Faster. There may also be a total slide number and a current slide number in the loop. The current slide number may be altered to go directly to that slide in the loop.

In another embodiment, video control panel 460 is optional. The cursor control may hover over the main panel 420 while a control button associated with the cursor controller may be pressed to display a pop-up menu with options to control the main panel 420 in much the same way as the video control panel 460 does (for example: play, stop, first, last, next, etc.).

A sound control panel 430 includes buttons that control sound, such as voice and music. A MIDI or MP3 version may be played, for instance. For example, when a play button is pressed, MP3 or MIDI version of the musical work associated with the image in the main panel 420 starts to play. A verbal presentation, such as a Podcast, or a narrative describing the presentation may be available by clicking buttons, where pressing one button to start the audio player takes exclusive control, so that one source at-a-time may be accessed, in an embodiment. In other embodiments, multiple sources may be played at a time. The user can also turn off the sound with an additional command button. The sound control panel 430 is optional. The cursor control may hover over main panel 420 while a control button associated with the cursor controller may be pressed to display a pop-up menu with options to control the audio associated with the main panel 420 in much the same way as the sound control panel 430 does (the pop-up menu includes the play, stop, volume, etc. options).

The button when pressed also may change color, and information about the work, for example: “Lower your speaker volume—Beethoven's 5th is about to come crashing through!” may be presented in the information panel 450. Having buttons to present a choice of music was developed to create greater user-control of the presentation, and having at least two versions of the music work gives an alternative if a user's system may not play one format or the other.

The information panel 450 includes a Text Control Confirmation Information bar. The text may be scrolling. The rationale is that every control button that is hovered on or clicked has a written explanation of that act. Every act of control may be verified in writing in this Text Information bar.

Hovering over controls may give an explanation of the control. Hovering over or selecting one of the control buttons, for example, the Faster button, may produce an explanation of its function in the information panel 450.

A search panel may also be included in the interface. The search panel may include an index of topics and may include a keyword search option. The keywords may access information, which may be typed or spoken into the system.

### Platform Architecture

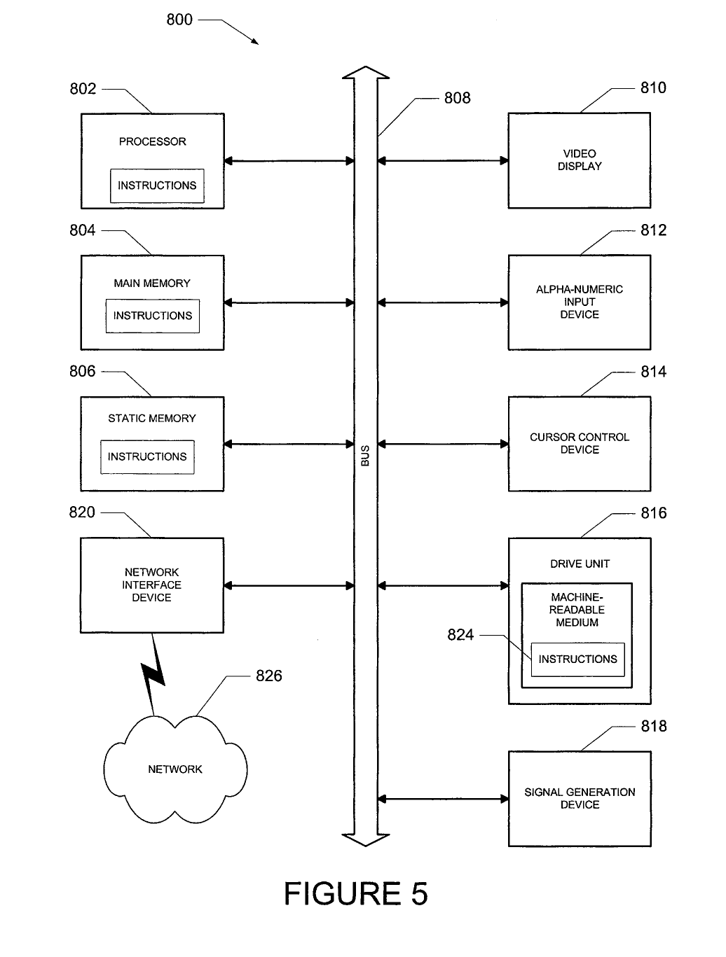

FIG. 5 shows a diagrammatic representation of a machine in the example form of a computer system 800 within which a set of instructions, for causing the machine to perform any one or more of the methodologies discussed herein, may be executed. In alternative embodiments, the machine operates as a standalone device or may be connected (e.g., network) to other machines. In a network deployment, the machine may operate in the capacity of a server or a client user machine in server-client user network environment, or as a peer machine in a peer-to-peer (or distributed) network environment. The machine may be or may access a GPS device, a server computer, a client user computer, a personal computer (PC), a tablet PC, a set-top box (STB), a Personal Digital Assistant (PDA), a handheld device, a cellular telephone, a mobile device, a calculator, a palmtop computer, a laptop computer, a desktop computer, a personal digital assistant, a communications device, a wireless telephone, a land-line telephone, a data player, a data recorder, a data transceiver, a control system, a video or still image camera, a scanner, a facsimile machine, a printer, a television, a pager, a personal trusted device, a web appliance, a network router, switch or bridge, or any machine capable of executing a set of instructions (sequential or otherwise) that specify actions to be taken by that machine.

Further, while a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824) embodying any one or more of the methodologies or functions described herein. The instructions 824 may also reside, completely or at least partially, within the main memory 804, the static memory 806, and/or within the processor 802 during execution thereof by the computer system 800. The main memory 804 and the processor 802 also may constitute machine-readable media.

The instructions 824 may further be transmitted or received over a network 826 via the network interface device 820.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The illustrations of embodiments described herein are intended to provide a general understanding of the structure of various embodiments, and the illustrations are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. FIGS. 1 to 5 are merely representational and may not be drawn to scale. Certain proportions thereof may be exaggerated, while others may be minimized.

Thus, a method and system to publish an electronic interface have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The description includes terms, such as “up”, “down”, “upper” “lower”, “first”, “second”, “vertical”, “horizontal”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the examples of dimensions and ranges are considered typical, the various embodiments are not limited to such dimensions or ranges.

The Abstract may be provided to comply with 37 C.F.R. §1.74(b) to allow the reader to quickly ascertain the nature and gist of the technical disclosure. The Abstract is submitted with the understanding that it will not be used to interpret or limit the scope or meaning of the claims. In the Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

What is claimed is:

1. A system comprising:
an electronic interface including:
a scrolling panel including a plurality of image slides, the plurality of image slides including at least one video slide, the plurality of image slides in a scrolling slideshow; and
a main panel including one of the plurality of image slides selected to be featured.

2. The system of claim 1 wherein the plurality of image slides in the scrolling panel are video thumbnails, and the selected image slide in the main panel is larger than the thumbnail counterpart.

3. The system of claim 1 further comprising a sound control panel for the main panel and scroll control for the scrolling panel, wherein the scroll control includes a loop scroll control.

4. The system of claim 1 wherein the plurality of image slides automatically scroll in a loop on the interface in sync with the selected one of the plurality of image slides on the main panel, as the selected one changes in succession through the loop.

5. The system of claim 1 wherein the video and audio portions of the selected one of the plurality of image slides are in sync with each other.

6. The system of claim 1 wherein the plurality of image slides include at least one still image slide.

7. The system of claim 1 wherein the plurality of image slides is selected directly by the user.

8. The system of claim 1 wherein the scrolling panel and the main panel are capable of being controlled by use of a hovering cursor with an activatable pop-up menu.

9. The system of claim 1 wherein the scrolling panel and the main panel are capable of being controlled by use of a hovering cursor with an activatable pop-up menu for sound control and scroll control.

10. A method comprising:
publishing an interface including a scrolling panel of a plurality of image slides, the plurality of image slides including at least one still image slide and at least one video slide, the plurality of image slides in a scrolling slideshow; and including a main panel of one of the plurality of image slides selected to be featured, wherein a cursor hovers over the scrolling panel and main panel for sound control and scroll control.

11. The method of claim 10 further comprising updating at least one image of the plurality of image slides automatically.

12. The method of claim 11 further comprising updating through web feeds.

13. The method of claim 10 wherein the plurality of image slides in the scrolling panel are video thumbnails, and the selected image slide in the main panel is larger than the thumbnail counterpart.

14. The method of claim 10 further comprising a sound control panel for the main panel and scroll control for the scrolling panel, wherein the scroll control includes a loop scroll control.

15. The method of claim 10 wherein the plurality of image slides automatically scroll in a loop on the interface in sync with the selected one of the plurality of image slides on the main panel, as the selected one changes in succession through the loop.

16. The method of claim 10 wherein the plurality of image slides is located by a navigation application of the system.

17. The method of claim 10 wherein the scrolling panel and the main panel are capable of being controlled by use of a hovering cursor with an activatable pop-up menu.

18. The method of claim 10 wherein the scrolling panel and the main panel are capable of being controlled by use of a hovering cursor with an activatable pop-up menu for sound control and scroll control.

19. A machine-readable medium storing a sequence of instructions that, when executed by a computer, cause the computer to
publish an electronic interface including a scrolling panel of a plurality of image slides, the plurality of image slides including at least one still image slide and at least one video slide, the plurality of image slides in a scrolling slideshow; and including a main panel of one of the plurality of image slides selected to be featured, wherein a cursor hovers over the scrolling panel and main panel for sound control and scroll control.

20. The medium of claim 19 wherein the at least one video slide is played in substantial real-time.
